(19) United States
(12) Patent Application Publication
(10) Pub. No.: US 2011/0078915 A1
(43) Pub. Date: Apr. 7, 2011

(54) VALVE EXHAUSTING APPARATUS AND A DRIER OF FOOD TREATMENT SYSTEM HAVING IT

(75) Inventors: Sung Jin Kim, Seoul (KR); Sang Gu Sim, Goyang-si (KR); Ki Chul Kim, Seoul (KR)

(73) Assignee: WOONGJIN COWAY. LTD., Gongju-si (KR)

(21) Appl. No.: 12/921,139

(22) PCT Filed: Sep. 4, 2008
(86) PCT No.: PCT/KR08/05216

§ 371 Date: Dec. 1, 2010

(30) Foreign Application Priority Data
Mar. 18, 2008 (KR) 10-2008-0024996
Aug. 26, 2008 (KR) 10-2008-0083563

(51) Int. Cl. D06F 58/04; B02C 7/12; F16K 31/04

(52) U.S. Cl. 34/126; 241/277; 251/129.01

(57) ABSTRACT

An exhaust valve apparatus and a drier of a food treatment system having the exhaust valve apparatus are disclosed. The drier includes a drum having an input port and a discharge port. A stirring screw is rotatably disposed in the drum, and includes rotary blades for stirring and crushing the food waste and a rotating shaft for supporting the rotary blades. A power supply unit is provided on a surface of the drum and provides power to the stirring screw to rotate the stirring screw. A heater is provided on the outer surface of the drum body and provides high temperature heat to the inner space of the drum when electric power is applied to the heater, thus drying the food waste. An exhaust apparatus is mounted to the lower surface of the discharge port to open or close the discharge port.

### TECHNICAL FIELD

The present invention relates, in general, to a drier of a food treatment system having an axial or radial exhaust valve apparatus and, more particularly, to a drier of a food treatment system having an axial or radial exhaust valve apparatus, which allows dried food waste to be easily cut and discharged to the outside, and enables the discharged food waste to be evenly dispersed.

### BACKGROUND ART

Generally, in order to dispose of food waste, a fermentation treatment method, an incineration treatment method, a method of recycling food waste as feed or fertilizer (manure), a method of putting food waste in a landfill, and other methods are used. However, the above-mentioned methods require large facilities, may generate offensive odors or lead to inconveniences of collection, conveyance or storage of food waste, and may cause serious social problems such as environmental pollution.

Therefore, there has been an urgent demand for a method of reducing environmental pollution resulting from food waste and recycling the food waste.

Meanwhile, although the total number of households in Korea has passed ten million households, measures for the disposal of food waste which may cause environmental pollution are not yet sufficient. The main cause of the insufficient measures is due to the housewives' lack of understanding of the waste of resources and of environmental pollution.

Thus, in order to reduce the amount of food waste and efficiently recycle the food waste, there is a pressing need for the development of a food treatment system for home use which overcomes the above-mentioned problems.

Generally, a food treatment system which is connected to a sink of a home to dispose of food waste performs a series of processes, including dehydrating, cutting, and drying processes, thus removing water from the food waste and reducing the volume of the food waste, therefore dramatically reducing the discharged amount of the food waste.

Each of the conventional food treatment systems which is attached to a sink to dispose of food waste or an individual free standing type food treatment system includes an input port into which food waste is put, a dehydrating/cutting unit which compresses the food waste to dehydrate it and cut it into small pieces, a feeding unit which feeds the dehydrated and cut food waste to one side, a drier which evenly churns and disperses the dehydrated and cut food waste using a rotary blade rotated in one direction by a motor and removes water from the food waste using the high temperature heat, and a discharge box which stores the food waste which has been discharged after being dried.

Meanwhile, after the remaining water has completely removed from the food waste using the high temperature heat of the drier, the entirety of food waste is discharged through a discharge port which is bored through the bottom of the drier. After the entirety of food waste has been discharged from the drier, food waste which was dehydrated and cut by the dehydrating/cutting unit is continuously put into the drier, so that the operation of drying the food waste is performed repeatedly.

However, when the food waste put into the drier contains a large amount of starch or water, the viscosity of the food waste which is stirred and crushed by the rotary blade is high, so that the food waste may be accumulated around the discharge port and thereby the discharge port may become clogged.

Particularly, the accumulated food decays, so that the surroundings of the drier may be contaminated, and the drier of the food treatment system may become damaged.

### DISCLOSURE OF INVENTION

### Technical Problem

Accordingly, the present invention has been made keeping in mind the above problems occurring in the prior art, and an object of the present invention is to provide a drier of a food treatment system having an axial or radial exhaust valve apparatus, which allows dried food waste to be easily cut and discharged to the outside, and enables the discharged food waste to be evenly dispersed.

### Technical Solution

In order to accomplish the above object, the present invention provides a food waste exhaust apparatus for a food treatment system, including a valve unit provided in a discharge port of the food treatment system to open or close the discharge port; a power supply unit for supplying power to the valve unit to open or close the valve unit; and a power transmission unit provided between the power supply unit and the valve unit, for transmitting power from the power supply unit to the valve unit; wherein the valve unit is rotated in a vertical or horizontal direction relative to the power transmission unit.

The power transmission unit is a shaft.

Further, the valve unit comprises a shaft valve unit.

The valve unit is rotated by the power transmitted to the valve unit.

The power supply unit comprises a motor.

The food waste exhaust apparatus further includes a sensor unit for detecting a position of the valve unit.

In order to accomplish the above object, the present invention provides a drier for a food treatment system, including a drum having an input port into which food waste is put and a discharge port through which dried food waste is discharged; a stirring screw rotatably disposed in the drum, and comprising rotary blades for stirring and crushing the food waste put into the drum, and a rotating shaft for supporting the rotary blades; a power supply unit provided on a surface of the drum and providing power to the stirring screw to rotate the stirring screw; a heater provided on an outer surface of a drum body and providing high temperature heat to an inner space of the drum when electric power is applied to the heater, thus drying the food waste; and an exhaust apparatus mounted to a lower surface of the discharge port and controlling the discharge port so that it is opened or closed, the exhaust apparatus being rotated in a vertical or horizontal direction relative to the rotating shaft of the stirring screw.

The drier further includes a crush unit provided on an inner wall of the drum to which the power supply unit and the stirring screw are connected, the crush unit including a circular crush plate having a plurality of crush blades which are obliquely provided on the circular crush plate in a radial direction thereof, and an arch-shaped crush plate support provided on an upper portion of the crush plate.

The crush plate support includes a circular plate member provided to surround the crush plate, and a rib member provided on an outer surface of the plate member in a radial direction thereof.

The rotary blades each have a hook shape and are arranged such that ends thereof face each other, with a space defined between the rotary blades.

The rotary blades are removably provided on a circumference of the rotating shaft.

The exhaust apparatus includes a valve unit provided in the discharge port of the food treatment system to open or close the discharge port; a power supply unit for supplying power to the valve unit to open or close the valve unit; and a power transmission unit provided between the power supply unit and the valve unit, and transmitting power from the power supply unit to the valve unit, wherein the exhaust apparatus comprises an axial exhaust valve apparatus which is constructed so that the valve unit is oriented in an axial direction thereof on the drum or a radial exhaust valve apparatus which is constructed so that the valve unit is oriented in a radial direction thereof on the drum.

The power transmission unit is a shaft.

The valve unit comprises a shaft valve unit.

The valve unit is rotated by the power transmitted to the valve unit.

The power supply unit is a motor.

The drier further includes a sensor unit for detecting a position of the valve unit.

The axial exhaust valve apparatus includes a shaft valve unit having on each of opposite ends thereof a cylindrical support shaft, and having on a central portion of the valve unit a semi-cylindrical valve which has a diameter larger than that of the support shaft, with a cam mounted to an end of the support shaft and having on a surface thereof a protrusion.

The axial exhaust valve apparatus further includes a discharge port support part attached to a lower surface of the elliptical discharge port which is oriented in an axial direction, and installed in an axial direction of the drier, the discharge port support part including a semi-circular shaft seating groove which is provided on each of opposite ends of the discharge port support part to receive the support shaft, and an opening which is provided in a central portion of the discharge port support part to correspond to the discharge port; and a cuboid support bracket attached to each of the opposite ends of the discharge port support part, with a semi-circular insert groove provided in a central portion of the support bracket in a longitudinal direction thereof.

The valve is coated with Teflon.

The radial exhaust valve apparatus comprises a shaft valve unit including a support shaft provided on each of opposite ends of the shaft valve unit and having a shape of a square pillar, a cylindrical valve having a groove which is formed in a central portion of the valve such that the valve has a semi-circular cross-section, and a hollow cylindrical bushing member provided on a joint between the support shaft and the valve, with a cam mounted to an end of the support shaft and having on a surface thereof a protrusion.

Further, the radial exhaust valve apparatus includes a cuboid discharge port support part attached to a lower surface of the elliptical discharge port which is oriented in a radial direction, the discharge port support part having a semi-circular shaft seating groove which is provided on each of opposite ends of the discharge port support part to receive the support shaft, and an opening which is formed in a central portion of the discharge port support part to correspond to the discharge port; a packing member provided between the discharge port support part and the shaft valve unit, an inner surface of the packing member being shaped to seal a gap between the discharge port support part and the shaft valve unit; and a cuboid support bracket attached to each of the opposite ends of the discharge port support part, with a semi-circular insert groove provided in a central portion of the support bracket in a longitudinal direction thereof to receive the support shaft.

The valve is coated with Teflon.

The drier further includes a sensor unit which has a sensor for detecting contact pressure with the protrusion of the cam during rotation of the cam, and a bracket for supporting the sensor.

### Advantageous Effects

According to the present invention, a drier of a food treatment system having an axial or radial exhaust valve apparatus allows dried food waste to be easily cut prior to being discharged to the outside, thus preventing the food waste from accumulating and from decaying, therefore keeping the surroundings of the drier clean and preventing damage to the drier. Further, the drier of the present invention permits the discharged food waste to be evenly dispersed, thus preventing the discharged food waste from collecting in only one place. Further, the drier of the present invention detects the operation of a valve unit using a micro sensor, so that it is easy to control the valve unit.

### BRIEF DESCRIPTION OF DRAWINGS

FIG. 1 is a front top perspective view illustrating a drier 100 of a food treatment system according to one embodiment of the present invention,

FIG. 2 is a rear top perspective view illustrating the drier 100 of the food treatment system of FIG. 1,

FIG. 3 is a side view illustrating the drier 100 of the food treatment system of FIG. 1,

FIG. 4 is a bottom perspective view illustrating the drier 100 of the food treatment system of FIG. 1,

FIG. 5 is an exploded perspective view illustrating an axial exhaust valve apparatus 180 of the drier 100 of the food treatment system shown in FIG. 1,

FIG. 6 is a sectional view illustrating the axial exhaust valve apparatus 180 of the drier 100 of the food treatment system shown in FIG. 1, with the axial exhaust valve apparatus open,

FIG. 7 is a perspective view illustrating a crush unit 160 of the drier 100 of the food treatment system according to one embodiment of the present invention,

FIG. 8 is a front top perspective view illustrating a drier 200 of a food treatment system according to another embodiment of the present invention,

FIG. 9 is a rear top perspective view illustrating the drier 200 of the food treatment system of FIG. 8,

FIG. 10 is a side view illustrating the drier 200 of the food treatment system of FIG. 8,

FIG. 11 is a bottom perspective view illustrating the drier 200 of the food treatment system of FIG. 8,

FIG. 12 is an exploded perspective view illustrating a radial exhaust valve apparatus 280 of the drier 200 of the food treatment system shown in FIG. 8,

FIG. 13 is an exploded perspective view illustrating a shaft valve unit 283 of the radial exhaust valve apparatus 280 of FIG. 8, and

FIG. 14 is a sectional view illustrating the radial exhaust valve apparatus 280 of the drier 200 of the food treatment system shown in FIG. 8, with the radial exhaust valve apparatus open.

### MODE FOR THE INVENTION

The above and other objects, features and advantages of the present invention will be more clearly understood from the following detailed description taken in conjunction with the accompanying drawings. Hereinafter, a drier of a food treatment system having an axial or radial exhaust valve apparatus according to the preferred embodiment of the present invention will be described in detail with reference to the accompanying drawings.

First, a drier 100 of a food treatment system having an axial exhaust valve apparatus 180 will be described in detail with reference to the accompanying drawings.

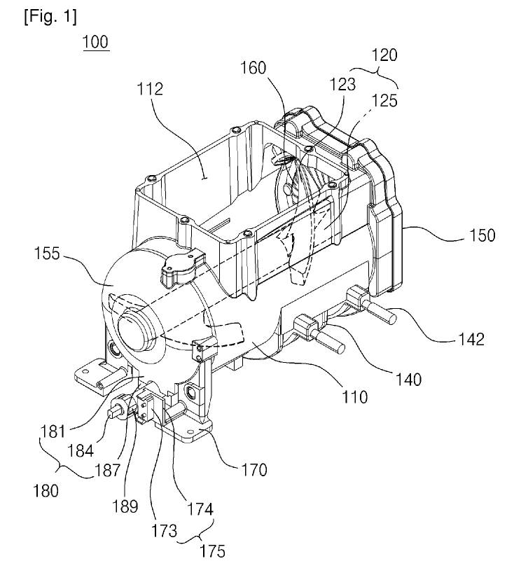

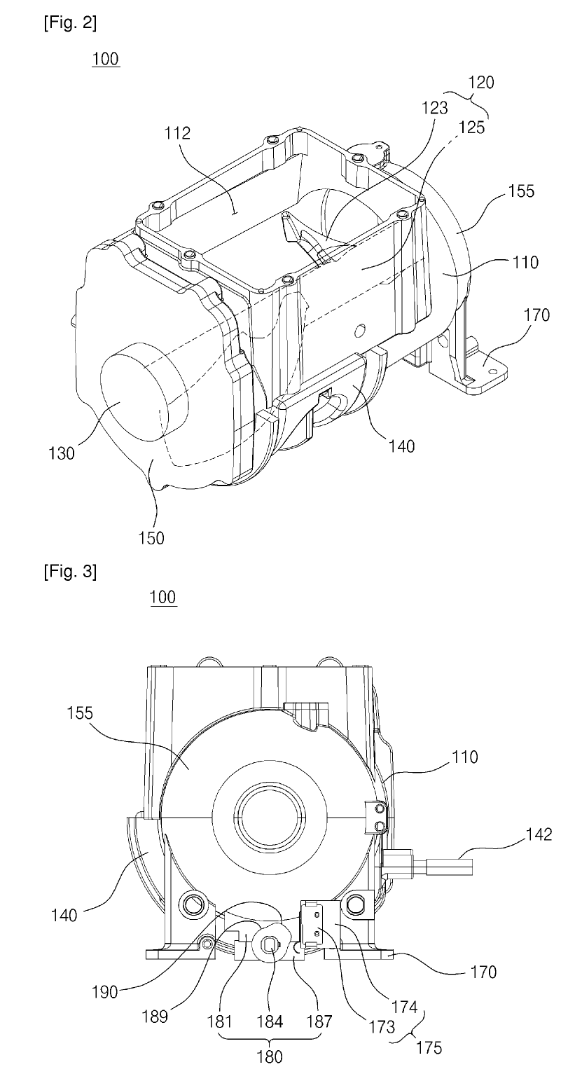

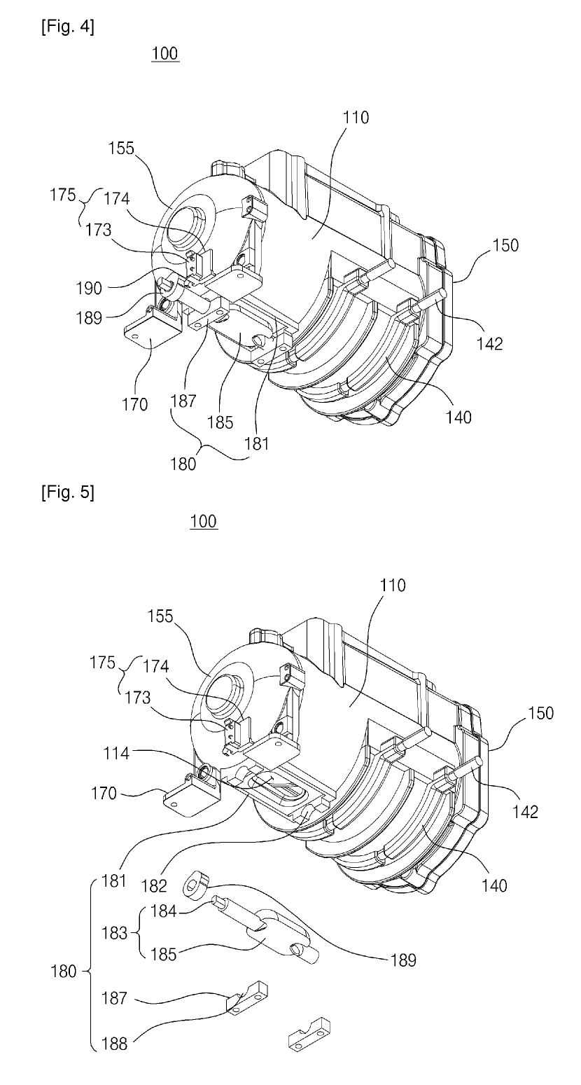

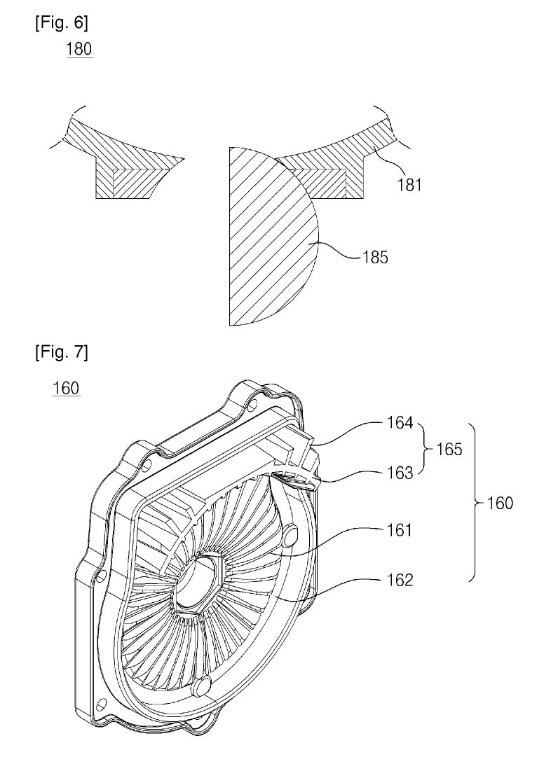

FIG. 1 is a front top perspective view illustrating a drier 100 of a food treatment system according to one embodiment of the present invention, FIG. 2 is a rear top perspective view illustrating the drier 100 of the food treatment system of FIG. 1, FIG. 3 is a side view illustrating the drier 100 of the food treatment system of FIG. 1, FIG. 4 is a bottom perspective view illustrating the drier 100 of the food treatment system of FIG. 1, FIG. 5 is an exploded perspective view illustrating an axial exhaust valve apparatus 180 of the drier 100 of the food treatment system shown in FIG. 1, and FIG. 6 is a sectional view illustrating the axial exhaust valve apparatus 180 of the drier 100 of the food treatment system shown in FIG. 1, with the axial exhaust valve apparatus open.

Referring to FIGS. 1 to 6, the drier 100 of the food treatment system having the axial exhaust valve apparatus 180 according to one embodiment of the present invention includes a cylindrical drum 110, a stirring screw 120, a power supply unit 130, a heater 140, and an axial exhaust valve apparatus 180. The cylindrical drum 110 is provided with an input port 112 into which dehydrated food waste is input, and an elliptical discharge port 114 which is oriented in the axial direction of the drum to discharge the dried food waste. The stirring screw 120 is rotatably positioned in the drum 110, and is provided with a plurality of rotary blades 123 which stir and crush the food waste input into the drum 110 and a rotating shaft 125 which supports the rotary blades 123. The power supply unit 130 is provided on one end of the drum 110 and provides power to the stirring screw 120, rotating the stirring screw 120. The heater 140 is provided on the outer surface of the body of the drum 110 and provides high temperature heat to the interior of the drum 110 when electricity is applied to the heater 140, thus drying the food waste. The axial exhaust valve apparatus 180 is mounted to the lower surface of the elliptical discharge port 114 which is formed in the axial direction, and opens or closes the elliptical discharge port 114 according to the dry state in the drum 110.

The drier 100 of the food treatment system according to the present invention functions to leave some of the completely dried food waste on the bottom in the drying space so as to be mixed with food waste which is continuously input into the drier, thus reducing the viscosity of all food waste in the drying space.

The drum 110 is provided with the input port 112 which is formed in the upper surface of the drum body, and the elliptical discharge port 114 which is axially formed in the bottom of the drum body. The drum is the hollow cylindrical holding member which has an internal space of a predetermined size to hold a predetermined amount of food waste.

The drum may have the external appearance of a hexahedron, sphere or other shapes. The discharge port may have the shape of an ellipse which is oriented in a radial direction, or the shape of a circle or polygon which has no directional orientation.

The input port 112 of a predetermined size is formed in the upper surface of the body of the drum 110 which is arranged horizontally so that food waste which is dehydrated and cut while passing through a hopper coupled to a sink (not shown) is put into the drum 110.

The elliptical discharge port 114 oriented in the axial direction is provided in the bottom of the drum body, so that food waste which is completely dried by eliminating water using a high temperature heat source in the drum 110 is discharged through the discharge port.

The drum 110 is preferably manufactured through casting using a metal material having high heat conductivity. A stainless steel material is mainly used for the drum 110.

The stirring screw 120 is provided in the drum 110 in such a way as to rotate forwards or backwards, thus stirring and crushing the food waste which is input through the input port 112 into the drum 110.

Further, the stirring screw may be provided in the axial or radial direction of the drum according to the shape of the drum. Of course, the stirring screw may be provided to increase crushing efficiency regardless of direction.

The stirring screw 120 is the rotary member which is constructed so that a plurality of rotary blades or a single blade 123 is mounted to the outer surface of the rod-shaped rotating shaft 125. One end of the rotating shaft 125 is connected to the power supply unit 130 provided on a front cap 150, while the other end is installed and supported in a shaft hole (not shown) of a rear cap 155. As the power supply unit 130, various types of motors may be used.

In this case, a predetermined interval is defined between the inner surface of the drum 110 and the outer end of each rotary blade 123 of the stirring screw 120 such that the rotary blades 123 can rotate smoothly without interference.

Each rotary blade 123 has the shape of a hook such that it is bent at an end thereof, and is rotatably installed in the drum 110 to stir and crush the food waste which is input into the drum 110. The rotary blades 123 are provided on the rotating shaft 125.

Further, the rotary blades may be provided radially around the rotating shaft.

The rotary blades may be provided such that space is defined between the rotary blades 123 and the hook-shaped ends of the rotary blades 123 face each other. The space is formed by cutting predetermined portions between the rotary blades 123 which are coupled into a single structure. Thereby, the end of each rotary blade 123 is formed to have the hook shape.

Each rotary blade 123 may be removably provided on the circumference of the rotating shaft 125. Thus, when a rotary blade 123 is broken or bent, the rotary blade 123 may be replaced with a new one, so that the stirring screw 120 can be used for a lengthy period of time.

If the stirring screw 120 having the rotary blades 123 which are constructed as described above is used, the accumulation of the food waste is prevented during the rotation of the rotary blades 123, and the power supply unit 130 is not overloaded.

That is, some of food waste is discharged between the rotary blades 123, so that the food waste does not accumulate. The food waste is pulled into the drier by the hook-shaped ends of the rotary blades 123, and thereby the power supply unit 130 is not overloaded.

The power supply unit 130 serves as the drive source for rotating the stirring screw 120 installed in the drum 110 forwards or backwards.

A support bracket 170 is provided on the lower portion of the rear cap 155 to surround the lower end of the rear cap 155 and support the entire drier 100. In order to install the drier 100 in the main body of the food treatment system, a fastening member may be fastened to holes which are formed in the support bracket 170 and have a predetermined size.

A crush unit 160 is installed at an end of the stirring screw 120 to crush the food waste fed by the stirring screw 120. When the stirring screw 120 is rotated backwards, the food waste is fed towards the crush unit 160. In contrast, when the stirring screw 120 is rotated forwards, the food waste is fed towards the discharge port 114.

The heater 140 is provided on the outer surface of the drum 110 and provides heat of high temperature to the inner space of the drum 110 serving as the drying space, when electricity is applied to the heater, thus removing water from the food waste which is input into the inner space, and thereby completely drying the food waste.

Such a heater 140 comprises a heating plate which is attached to the outer surface of the drum 110 and has superior heat conductivity, and is electrically connected to an electric power supply unit 142. A sheath heater may be used as the heater 140.

A discharge box (not shown) is provided on the lower end of the drier 100 of the food treatment system to collect the food waste which is discharged from the discharge port 114.

After the food waste is input into the inner space through the input port 112 of the drum 110, water is completely removed from the food waste by the heat source provided by the heater 140. Thereby, the dried food waste is fed to the discharge port 114 while being stirred and crushed by the stirring screw 120.

Further, most of the food waste is discharged through the discharge port 114 to the discharge box (not shown), but food waste which is not dried or some of the dried food waste adheres to the inner surface of the drum 110 and thereby remains in the drum. Particularly, when the stirring screw 120 is rotated backwards, so that the food waste is crushed by the crush unit 160, some of the food waste may stick to the surrounding area of the crush unit 160. Thereby, the power supply unit 130 for rotating the stirring screw 120 may be overloaded.

In order to solve the problem, the structure of the crush unit 160 may be modified.

FIG. 7 illustrates the crush unit 160 of the drier 100 of the food treatment system according to one embodiment of the present invention.

The crush unit 160 according to the present invention includes a crush plate 162 which directly crushes food waste, and a crush plate support 165 which supports the crush plate.

The circular crush plate 162 is mounted to the inner wall of the drum 110 to which the power supply unit 130 and the stirring screw 120 are connected, and a plurality of crush blades 161 is obliquely provided on the circular crush plate 162 in a radial direction thereof. The arch-shaped crush plate support 165 is mounted to the upper portion of the crush plate 162.

The food waste fed by the stirring screw 120 may be crushed in a radial direction by the circular crush plate 162.

The crush plate support 165 has an arch shape. Thus, the crush plate support does not contact the outer ends of the rotary blades 123 of the stirring screw 120 even when the stirring screw 120 is rotated.

The crush plate support 165 includes a circular plate member 163 which is provided to surround the crush plate 162, and rib members 164 which are provided on the outer surface of the plate member 163 in a radial direction.

The rib members 164 support the plate member 163 in the radial direction, thus preventing the plate member 163 from being deformed even if a large amount of food waste adheres to the plate member.

Further, the crush plate support 165 may adjust the amount of the food waste fed to the crush plate 162, thus preventing damage to the crush unit 160 or the stirring screw 120 and preventing food waste caught in the crush unit 160 from adhering thereto, therefore preventing the power supply unit 130 from becoming overloaded.

Referring to FIGS. 1 to 6, the axial exhaust valve apparatus 180 includes a shaft valve unit, a discharge port support part, and support brackets. The shaft valve unit 183 has on both sides thereof cylindrical support shafts 184 and has on the central portion thereof a valve 185 which has a larger diameter than that of each support shaft 184 and has the shape of a semi-cylinder. A cam 189 having on a surface thereof a protrusion 190 is fitted over one end of the support shaft 184. The discharge port support part 181 is attached to the lower surface of the elliptical discharge port 114 which is oriented in the axial direction. Shaft seating grooves 182 each having a semi-circular shape are provided on the opposite ends of the discharge port support part to receive the corresponding support shafts 184, and an opening is formed in the central portion of the discharge port support part to correspond to the discharge port 114. The discharge port support part is installed in the axial direction of the drier 100. The support brackets 187 are attached to the opposite ends of the discharge port support part 181. Each support bracket has the shape of a cuboid which has at a central portion in a longitudinal direction thereof a semicircular insert groove 188.

As the valve unit used in the exhaust valve apparatus, various valve units including a spherical valve unit and a plate valve unit may be used, in addition to the shaft valve unit. Of course, the shape of the discharge port and the installation position or operating method of a power transmission unit may be changed depending on the shape of the valve unit.

Further, the exhaust valve apparatus may further include a sensor unit 175 having a sensor which detects the contact pressure with the protrusion 190 of the cam 189 when the cam 189 is rotated, and a bracket 174 which supports the sensor. As the sensor, a micro sensor 173 and other types of sensors may be used.

FIG. 6 is a sectional view illustrating the axial exhaust valve apparatus 180, when the valve 185 is open. The curved part of the valve 185 of the shaft valve unit 183 of FIG. 6 is coated with Teflon, thus protecting the valve 185 against frictional force between the valve and food waste. Of course, an additional coating part (not shown) may be provided on the curved part of the valve 185, thus preventing damage to the valve 185 caused by the frictional force generated during the discharge of food waste.

The operation of the axial exhaust valve apparatus 180 will be described below with reference to FIG. 6. The axial exhaust valve apparatus 180 is operated in response to a signal of a control unit (not shown) when food waste is dried in the drier 100 of the food treatment system. Normally, the valve 185 of the axial exhaust valve apparatus 180 closes the discharge port 114. However, when the food waste is dried, the control unit operates the valve 185, thus rotating the valve at a predetermined angle (see FIG. 6). That is, the valve 185 of the shaft valve unit 183 has a semi-cylindrical shape. Thus, when the valve is positioned to be parallel to the surrounding area of the discharge port 114, the valve closes the discharge port 114. However, when the valve is rotated at a predetermined angle, the discharge port 114 is opened.

When the discharge port 114 is opened, the food waste fed by the rotation of the stirring screw 120 is discharged through the discharge port 114 to the outside. In this case, both ends of the valve 185 are formed to be sharp, thus easily cutting the dried food waste, prior to discharging the food waste to the outside. Such a construction prevents the accumulation of the food waste, thus preventing the food waste from decaying and preventing the surroundings of the drier from becoming contaminated, therefore preventing damage to the drier.

Further, the rotary blades 123 of the stirring screw 120 are spaced apart from the valve 185 of the shaft valve unit 183 by a predetermined interval. Thus, when the stirring screw 120 is rotated, the rotary blades 123 are not in contact with the valve 185 of the shaft valve unit 183, so that the rotary blades 123 are not damaged due to friction.

When a predetermined amount of power is supplied to the shaft valve unit 183, the shaft valve unit is rotated clockwise or counterclockwise. A device for determining the rotating direction and rotating angle of the valve 185 which is operated in the discharge port 114 is required. To this end, the sensor unit 175 having the micro sensor 173 and the bracket 174 may be further provided. The micro sensor functions to detect the contact pressure with the protrusion 190 of the cam 189 during the rotation of the cam 189. The bracket functions to support the micro sensor 173.

The most ideal operation of opening the valve 185 is to rotate the valve 185 clockwise to about 100˜120°. To this end, the micro sensor 173 is provided to a side of the cam 189 to detect the pressure applied by the protrusion 190 which is provided on a surface of the cam 189. That is, when the cam 189 is rotated at a predetermined angle, so that the protrusion 190 presses the micro sensor 173, the micro sensor 173 transmits a contact signal to the control unit, thus stopping the operation of the shaft valve unit 183. Further, after all of the dried food waste has been discharged through the discharge port 114 to the outside, the valve 185 is further rotated clockwise, thus closing the discharge port 114 (a clockwise rotation of about 250°).

Further, unless the shaft valve unit 183 is operated when a lot of food waste is caught in the surroundings of the valve 185, the micro sensor 173 does not detect the external pressure applied by the cam 189 even though a given time has elapsed. In this case, the valve 185 is operated in a direction where food waste is not caught by the control unit (not shown), so that the food waste is eliminated, and thereafter normal operation is performed. For example, if food is caught in the surroundings of the valve when the valve 185 is rotated clockwise to be opened, the control unit (not shown) operates the valve 185 counterclockwise, thus removing the food from the surroundings of the valve.

The bracket 174 is provided on the lower portion of the rear cap 155 of the drum 110 to support the micro sensor 173. In order to support the micro sensor, the bracket 174 may be provided with ribs, so that the micro sensor 173 is fitted between the ribs.

In this case, in order to supply power to the shaft valve unit 183, the power supply unit (not shown) such as a motor and the power transmission unit (not shown) such as a shaft or gear which transmits power from the power supply unit to the shaft valve unit 183 may be additionally provided.

Next, a drier 200 of a food treatment system having a radial exhaust valve apparatus 280 will be described in detail with reference to the accompanying drawings.

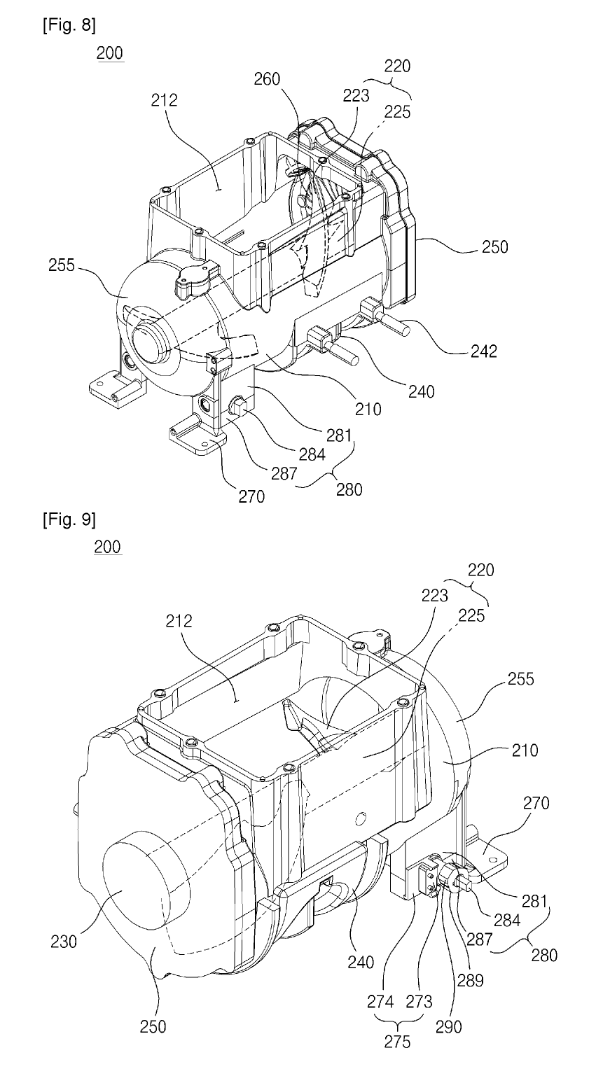

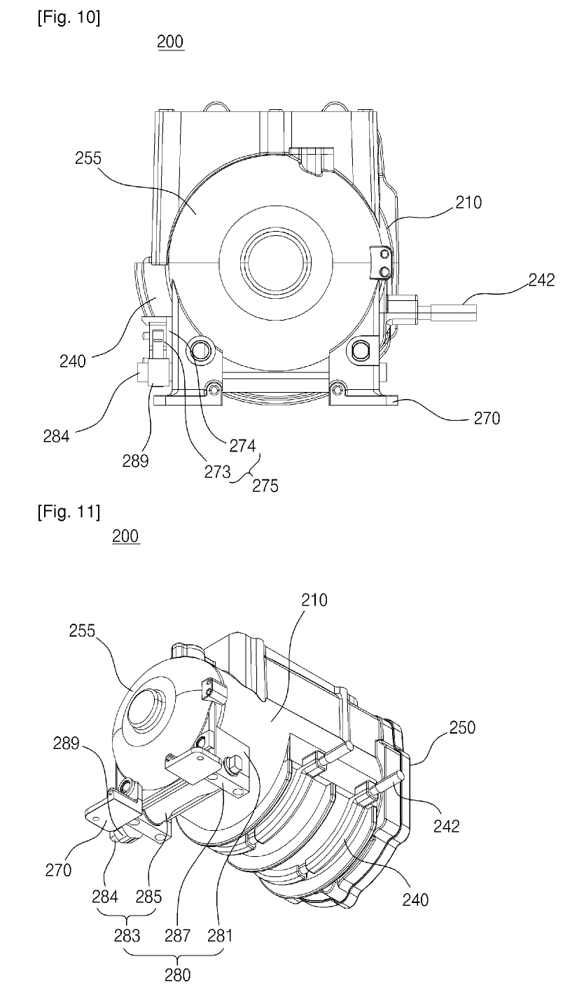

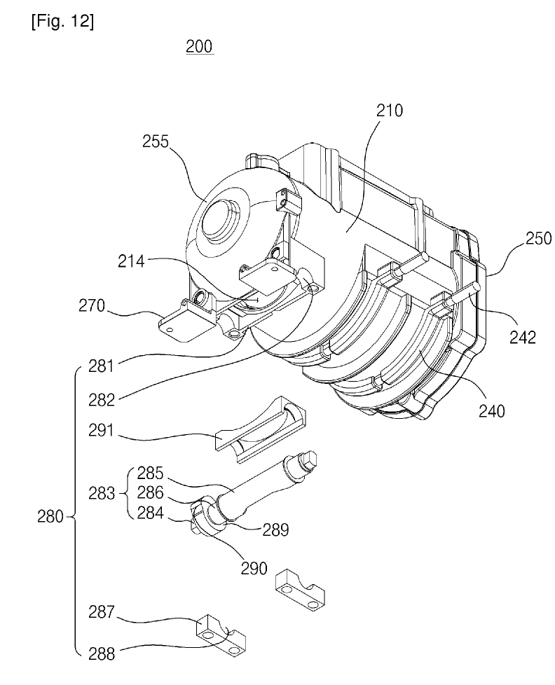

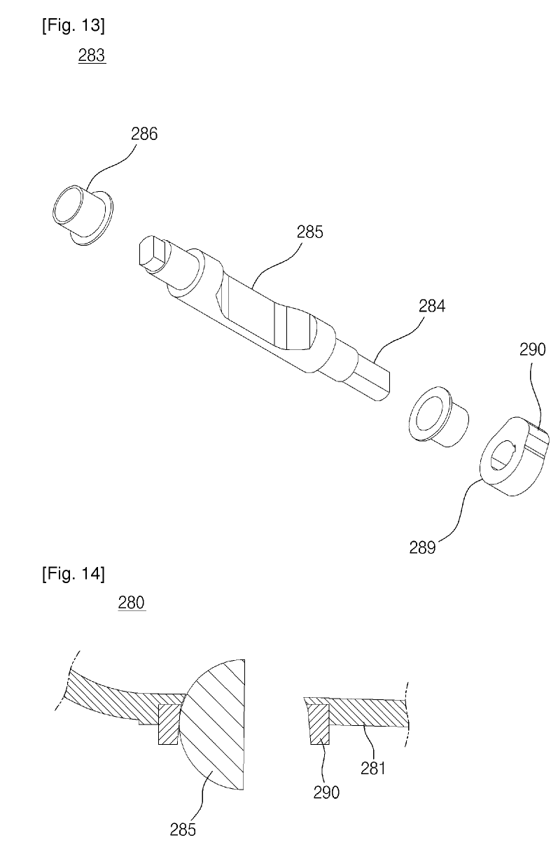

FIG. 8 is a front top perspective view illustrating a drier 200 of a food treatment system according to another embodiment of the present invention, FIG. 9 is a rear top perspective view illustrating the drier 200 of the food treatment system of FIG. 8, FIG. 10 is a side view illustrating the drier 200 of the food treatment system of FIG. 8, FIG. 11 is a bottom perspective view illustrating the drier 200 of the food treatment system of FIG. 8, FIG. 12 is an exploded perspective view illustrating a radial exhaust valve apparatus 280 of the drier 200 of the food treatment system shown in FIG. 8, FIG. 13 is an exploded perspective view illustrating a shaft valve unit 283 of the radial exhaust valve apparatus 280 of FIG. 8, and FIG. 14 is a sectional view illustrating the radial exhaust valve apparatus 280 of the drier 200 of the food treatment system shown in FIG. 8, with the radial exhaust valve apparatus open.

Referring to FIGS. 8 to 14, the drier 200 of the food treatment system having the radial exhaust valve apparatus 280 according to another embodiment of the present invention includes a cylindrical drum 210, a stirring screw 220, a power supply unit 230, a heater 240, and the radial exhaust valve apparatus 280. The cylindrical drum 210 is provided with an input port 212 into which dehydrated food waste is input, and an elliptical discharge port 214 which is oriented in the radial direction of the drum 210 to discharge the dried food waste. The stirring screw 220 is rotatably positioned in the drum 210, and is provided with a plurality of rotary blades 223 which stir and crush the food waste input into the drum 210 and a rotating shaft 225 which supports the rotary blades 223. The power supply unit 230 is provided on one end of the drum 210 and provides power to the stirring screw 120 to rotate the stirring screw. The heater 240 is provided on the outer surface of the body of the drum 210 and provides high temperature heat to the interior of the drum 210 when electricity is applied to the heater, thus drying the food waste. The radial exhaust valve apparatus 280 is mounted to the lower surface of the elliptical discharge port 214 which is formed in the radial direction, and opens or closes the elliptical discharge port 214 according to the dry state in the drum 210.

The elliptical discharge port 214 oriented in the radial direction is provided in the bottom of the drum 210 body, so that food waste which is completely dried by eliminating water using a high temperature heat source in the drum 210 is discharged through the discharge port.

The radial exhaust valve apparatus 280 includes a shaft valve unit 283, a discharge port support part, a packing member 291 and support brackets 287. Support shafts 284 each having the shape of a square pillar are provided on both sides of the shaft valve unit 283. A cylindrical valve 285 is provided on the central portion of the shaft valve unit, with a groove formed in the valve such that it has a semi-circular cross section. A hollow cylindrical bushing member 286 is provided on a joint between each support shaft 284 and the valve 285. A cam 289 is fitted over an end of an associated support shaft 284, and has on a predetermined portion thereof a protrusion 290. The cuboid discharge port support part 281 is attached to the lower surface of the elliptical discharge port 214 which is oriented in the radial direction. Shaft seating grooves 282 each having a semi-circular shape are provided on the opposite ends of the discharge port support part to receive the corresponding support shafts 284, and an opening is formed in the central portion of the discharge port support part to correspond to the discharge port 214. The packing member 291 is provided between the discharge port support part 281 and the shaft valve unit 283, and has the shape corresponding to that of the interior of the discharge port support part 281 to seal a gap between the discharge port support part and the shaft valve unit. The support brackets 287 are attached to the opposite ends of the discharge port support part 281. Each support bracket has the shape of a cuboid which has in a central portion in a longitudinal direction thereof a semicircular insert groove 288 to support the corresponding support shaft 284.

As the valve unit used in the exhaust valve apparatus, various valve units including a spherical valve unit and a plate valve unit may be used, in addition to the shaft valve unit. Of course, the shape of the discharge port and the installation position or operating method of a power transmission unit may be changed depending on the shape of the valve unit.

Further, the exhaust valve apparatus may further include a sensor unit 275 having a micro sensor 273 which detects the contact pressure with the protrusion 290 of the cam 289 when the cam 289 is rotated, and a bracket 274 which supports the micro sensor 273.

The operation of the radial exhaust valve apparatus 280 will be described below with reference to FIG. 14. The radial exhaust valve apparatus 280 is operated in response to a signal of a control unit (not shown) when food waste is dried in the drier 200 of the food treatment system. Normally, the shaft valve unit 283 of the radial exhaust valve apparatus 280 closes the discharge port 214. However, when the food waste is dried, the control unit operates the shaft valve unit 283, thus rotating the shaft valve unit at a predetermined angle (see FIG. 14). That is, the valve 285 of the shaft valve unit 283 has a semi-cylindrical shape. Thus, when the valve is positioned to be parallel to the surrounding area of the discharge port 214, the valve closes the discharge port 214. However, when the valve is rotated at a predetermined angle, the discharge port 214 is opened.

When a predetermined power is supplied to the shaft valve unit 283, the shaft valve unit is rotated clockwise or counterclockwise. A device for determining the rotating direction and rotating angle of the valve 285 which is operated in the discharge port 214 is required. To this end, the sensor unit 275 having the micro sensor 273 and the bracket 274 may be further provided. The micro sensor functions to detect the contact pressure with the protrusion 290 of the cam 289 during the rotation of the cam 289. The bracket functions to support the micro sensor 273.

The most ideal operation of opening the valve 285 is to rotate the valve 285 clockwise at about 100˜120°. To this end, the micro sensor 273 is provided to a side of the cam 289 to detect the pressure applied by the protrusion 290 which is provided to a surface of the cam 289. That is, when the cam 289 is rotated at a predetermined angle, so that the protrusion 290 presses the micro sensor 273, the micro sensor 273 transmits a contact signal to the control unit, thus stopping the operation of the shaft valve unit 283. Further, after all of the dried food waste has been discharged through the discharge port 214 to the outside, the valve 285 is further rotated clockwise, thus closing the discharge port 214 (a clockwise rotation of about 250°).

Further, unless the shaft valve unit 283 is operated when a lot of food waste is caught in the surrounding area of the valve 285, the micro sensor 273 does not detect the external pressure applied by the cam 289 even though a given time has passed. In this case, the valve 285 is operated in a direction where food waste is not caught by the control unit (not shown), so that the food waste is eliminated, and thereafter normal operation is performed.

The bracket 274 is provided on the lower portion of the rear cap 255 of the drum 210 to support the micro sensor 273. In order to support the micro sensor, the bracket 274 may be provided with ribs, so that the micro sensor 273 is fitted between the ribs.

In this case, in order to supply power to the shaft valve unit 283, the power supply unit (not shown) such as a motor and the power transmission unit (not shown) such as a shaft which transmits power from the power supply unit (not shown) to the shaft valve unit 283 may be additionally provided.

When the discharge port 214 is opened, the food waste fed by the rotation of the stirring screw 220 is discharged through the discharge port 214 to the outside. In this case, both ends of the valve 285 are formed to be sharp, thus easily cutting the dried food waste, prior to discharging the food waste to the outside. Such a construction prevents the accumulation of the food waste, thus preventing the food waste from decaying and preventing the surroundings of the drier from becoming contaminated, therefore preventing damage to the drier.

Further, the rotary blades 223 of the stirring screw 220 are spaced apart from the valve 285 of the shaft valve unit 283 by a predetermined interval. Thus, when the stirring screw 220 is rotated, the rotary blades 223 do not make contact with the valve 285 of the shaft valve unit 283, so that the rotary blades 223 are not damaged due to friction.

Since the construction and operation of the crush unit of the present invention remain the same as those of the crush unit 160 of FIG. 7, the drawing illustrating the crush unit will be omitted.

In order to operate the exhaust apparatus used in the drier of the food treatment system, a gear may be used as the power transmission unit.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A food waste exhaust apparatus for a food treatment system, comprising:
a valve unit provided in a discharge port of the food treatment system to open or close the discharge port;
a power supply unit for supplying power to the valve unit to open or close the valve unit; and
a power transmission unit provided between the power supply unit and the valve unit, for transmitting power from the power supply unit to the valve unit;
wherein the valve unit is rotated in a vertical or horizontal direction relative to the power transmission unit.

2. The food waste exhaust apparatus according to claim 1, wherein the power transmission unit is a shaft.

3. The food waste exhaust apparatus according to claim 1, wherein the valve unit comprises a shaft valve unit.

4. The food waste exhaust apparatus according to claim 1, wherein the valve unit is rotated by the power transmitted to the valve unit.

5. The food waste exhaust apparatus according to claim 1, wherein the power supply unit is a motor.

6. The food waste exhaust apparatus according to claim 1, further comprising a sensor unit for detecting a position of the valve unit.

7. A drier for a food treatment system, comprising:
a drum having an input port into which food waste is put and a discharge port through which dried food waste is discharged;
a stirring screw rotatably disposed in the drum, and comprising rotary blades for stirring and crushing the food waste put into the drum, and a rotating shaft for supporting the rotary blades;
a power supply unit provided on a surface of the drum and providing power to the stirring screw to rotate the stirring screw;
a heater provided on an outer surface of a drum body and providing high temperature heat to an inner space of the drum when electric power is applied to the heater, thus drying the food waste; and
an exhaust apparatus mounted to a lower surface of the discharge port and controlling the discharge port so that it is opened or closed, the exhaust apparatus being rotated in a vertical or horizontal direction relative to the rotating shaft of the stirring screw.

8. The drier according to claim 7, further comprising a crush unit provided on an inner wall of the drum to which the power supply unit and the stirring screw are connected, the crush unit including a circular crush plate having a plurality of crush blades which are obliquely provided on the circular crush plate in a radial direction thereof, and an arch-shaped crush plate support provided on an upper portion of the crush plate.

9. The drier according to claim 8, wherein the crush plate support comprises:
a circular plate member provided to surround the crush plate; and
a rib member provided on an outer surface of the plate member in a radial direction thereof.

10. The drier according to claim 7, wherein the rotary blades each have a hook shape and are arranged such that ends thereof face each other, with a space defined between the rotary blades.

11. The drier according to claim 7, wherein the rotary blades are removably provided on a circumference of the rotating shaft.

12. The drier according to claim 7, wherein the exhaust apparatus comprises:
a valve unit provided in the discharge port of the food treatment system to open or close the discharge port;
a power supply unit for supplying power to the valve unit to open or close the valve unit; and
a power transmission unit provided between the power supply unit and the valve unit, and transmitting power from the power supply unit to the valve unit,
wherein the exhaust apparatus comprises an axial exhaust valve apparatus which is constructed so that the valve unit is oriented in an axial direction thereof on the drum or a radial exhaust valve apparatus which is constructed so that the valve unit is oriented in a radial direction thereof on the drum.

13. The drier according to claim 12, wherein the power transmission unit is a shaft.

14. The drier according to claim 12, wherein the valve unit comprises a shaft valve unit.

15. The drier according to claim 12, wherein the valve unit is rotated by the power transmitted to the valve unit.

16. The drier according to claim 12, wherein the power supply unit is a motor.

17. The drier according to claim 12, further comprising:
a sensor unit for detecting a position of the valve unit.

18. The drier according to claim 12, wherein the axial exhaust valve apparatus comprises a shaft valve unit having on each of opposite ends thereof a cylindrical support shaft, and having on a central portion of the valve unit a semi-cylindrical valve which has a diameter larger than that of the support shaft, with a cam mounted to an end of the support shaft and having on a surface thereof a protrusion.

19. The drier according to claim 18, wherein the axial exhaust valve apparatus further comprises:
a discharge port support part attached to a lower surface of the elliptical discharge port which is oriented in an axial direction, and installed in an axial direction of the drier, the discharge port support part including a semi-circular shaft seating groove which is provided on each of opposite ends of the discharge port support part to receive the support shaft, and an opening which is provided in a central portion of the discharge port support part to correspond to the discharge port; and
a cuboid support bracket attached to each of the opposite ends of the discharge port support part, with a semi-circular insert groove provided in a central portion of the support bracket in a longitudinal direction thereof.

20. The drier according to claim 18, wherein the valve is coated with Teflon.

21. The drier according to claim 12, wherein the radial exhaust valve apparatus comprises a shaft valve unit including:
a support shaft provided on each of opposite ends of the shaft valve unit and having a shape of a square pillar;
a cylindrical valve having a groove which is formed in a central portion of the valve such that the valve has a semi-circular cross-section; and
a hollow cylindrical bushing member provided on a joint between the support shaft and the valve, with a cam mounted to an end of the support shaft and having on a surface thereof a protrusion.

22. The drier according to claim 21, wherein the radial exhaust valve apparatus comprises:
a cuboid discharge port support part attached to a lower surface of the elliptical discharge port which is oriented in a radial direction, the discharge port support part having a semi-circular shaft seating groove which is provided on each of opposite ends of the discharge port support part to receive the support shaft, and an opening which is formed in a central portion of the discharge port support part to correspond to the discharge port;
a packing member provided between the discharge port support part and the shaft valve unit, an inner surface of the packing member being shaped to seal a gap between the discharge port support part and the shaft valve unit; and
a cuboid support bracket attached to each of the opposite ends of the discharge port support part, with a semi-circular insert groove provided in a central portion of the support bracket in a longitudinal direction thereof to receive the support shaft.

23. The drier according to claim 21, wherein the valve is coated with Teflon.

24. The drier according to claim 18 or 21, further comprising a sensor unit including:
a sensor for detecting contact pressure with the protrusion of the cam during rotation of the cam; and
a bracket for supporting the sensor.
